(19) United States
(12) Patent Application Publication
(10) Pub. No.: US 2004/0160690 A1
(43) Pub. Date: Aug. 19, 2004

(54) Master disc for magnetic transfer, method of manufacturing the same, and magnetic transfer method

(76) Inventors: Hiroyuki Yoshimura, Tokyo (JP); Kiminori Sato, Nagano (JP)

Correspondence Address: ROSSI & ASSOCIATES, P.O. Box 826, Ashburn, VA, 20146-0826, US

(21) Appl. No.: 10/658,686

(22) Filed: Sep. 9, 2003

(30) Foreign Application Priority Data
Feb. 19, 2003 (JP) JP 2003-041804

(51) Int. Cl. G11B 5/86; G11B 5/09

(52) U.S. Cl. 360/16; 360/48

(57) ABSTRACT

A master disc has a pattern of soft magnetic film in which the length thereof or the interval between soft magnetic material and another soft magnetic material is kept less than a predetermined value. Blocks of 2-bit information are converted to the corresponding number of blocks each having at least 3-bits of servo address information of a servo signal. Each of the converted blocks contains at least one bit having a different value.

### BACKGROUND

Data is read from or written to a hard disc drive (HDD) device using a magnet head floated on the surface of a rotating recording medium with a gap of 10 nm using a floating mechanism (slider). Bit information on the magnetic recording medium is stored in data tracks arranged concentrically on the surface of the recording medium. The magnetic head is moved and positioned to a target track on the recording medium surface at a high speed to read or write data. A positioning signal (servo signal) for detecting the relative position between the magnetic head and the data tracks is concentrically written on the surface of the magnetic recording medium, and the magnetic head detects the position thereof at a fixed time interval while reading or writing data.

The servo signal is written using a dedicated device (servo writer) after the magnetic recording medium is installed in the HDD device so that the signal thus written does not deviate from the center of the recording medium or the center of the locus of the magnetic head. The recording density of the present HDD device already reached 100 Gbits/in² even at the developing stage, and it is being increased 60% per year. In connection with this increase, the recording density of the servo signal for position detection is likewise increased so that the writing time of the servo signal is likewise increased year by year. The increase of the writing time of the servo signal is a significant factor that reduces productivity of the HDD device and increases the cost thereof.

Therefore, a magnetic transfer technique has been recently developed to dramatically shorten the writing time of the servo signal in comparison to the above described servo writer. The magnetic transfer technique involves collectively writing a servo signal, as disclosed for instance in JP-A-2001-283433 and JP-A-10-40544.

FIGS. 1A-1C and 2A-2B show the magnetic transfer technique. FIG. 1A is a diagram showing an initial demagnetizing step of a magnetic recording medium 101, and an arrow represents a movement path of a permanent magnet. The magnetic layer is uniformly magnetized in the circumferential direction. As shown in FIG. 1B, a master disc for magnetic transfer (master disc) 102 is disposed and positioned on the magnetic recording medium 101. As shown in FIG. 1C, the master disc 102 is brought into close contact with the surface of the magnetic recording medium 101, and the permanent magnet for magnetic transfer is moved along the movement path indicated by an arrow b to magnetically transfer the servo signal embedded in the master disc 102 onto the magnetic recording medium 101.

FIG. 2A is a cross-sectional view of the magnetic recording medium showing the state where the permanent magnet 201 is moved on the surface of the magnetic recording medium, while it is spaced from the surface of the magnetic recording medium at a fixed interval or gap (1 mm or less). In the magnetic recording medium, magnetic film 202 is formed on the upper surface of a substrate 203, and the magnetic film 202 is initially not magnetized in a uniform direction. In the initial demagnetizing step, however, the permanent magnet 201 is moved in the movement direction indicated by the arrow to magnetize the magnetic film 202 in a uniform direction by the magnetic field leaking from the gap of the permanent magnet 201. The arrows in the magnetic film 202 represent the direction of the magnetization.

FIG. 2B is a diagram showing the transfer pattern writing step, where bit information such as a servo signal as a transfer pattern corresponding to a magnetic pattern is written. The master disc 102 is designed so that on a silicon substrate 205, a pattern of a soft magnetic film 204 representing a transfer pattern is embedded in the face of the master disc 102. The master disc 102 is positioned and brought into close contact with the magnetic recording medium 101 composed of a magnetic film 202 on a silicon substrate, and the permanent magnet 201 is moved in the movement direction of the arrow on the substrate of the master disc 102. Accordingly, the magnetic field leaking and infiltrating can pass through the silicon substrate 205 and magnetize the magnetic film 202 at positions where no soft magnetic film 204 is formed. On the other hand, at positions where the soft magnetic film 204 is formed, the magnetic field passes through the soft magnetic film 204 to form a magnetic path having small magnetic resistance. Thus, the magnetic field leaking from the silicon substrate 205 is reduced so that the magnetic film 202 of the magnetic recording medium 101 is not newly magnetized, maintaining the magnetism achieved in the magnetization direction in the initial demagnetizing step. By using this principle, the transfer pattern formed in the soft magnetic film 204 on the master disc can be transferred to the magnetic film 202 of the magnetic recording medium.

FIG. 3 shows a pattern of a servo signal 30-34 of some HDD devices. Normally, the servo signal is designed with the following format: servo AGC 30, servo detection pattern 31, which is a specific pattern for identifying a servo pattern, and servo address information 32, 33

The servo AGC (automatic gain control of an amplifier) 30, which serves two functions, AGC and servo clock synchronization, typically contains about 100 bits, although it is different in accordance with the mode of the device. The servo AGC 30 is associated with an AGC circuit of the amplifier for amplifying a signal read from a magnetic head. Normally, the AGC circuit of the amplifier operates ordinarily under the assumption that data is written in portions other than the servo signal. When no data is written in portions other than the servo signal or when a servo signal immediately after writing is read, the gain of the amplifier is kept approximately to the maximum. Thus, the servo signal cannot be normally read. Therefore, the gain can be returned to a normal value by the servo AGC existing as a preamble at the head of the servo signal. There would be no problem if the initial portion of the servo AGC were not normally read. Therefore, a dibit pattern of all “1”, which is a signal having a fixed frequency at a servo frequency, is first written in the servo signal. A clock for reading the servo signal is generated in a PLL (Phase Locked Loop) circuit, and is synchronized with this initial portion.

The servo address information 32, 33 includes cylinder information 32 and sector information 33. The cylinder information of a servo track is written while gray-coded. A HDD device positions the magnetic head to a target track based on the cylinder information, and reads or writes data there.

FIGS. 4A and 4B show a conversion table when the cylinder information is gray-coded. FIG. 4A shows a conversion pattern from binary codes to gray codes, and FIG. 4B shows the gray coded cylinder information. The gray coding varies the cylinder information between neighboring cylinders by the amount corresponding to only one bit so that the magnetic head is prevented from accessing a greatly different position even when the magnetic head erroneously reads the cylinder information. The number of the bits of the cylinder information is calculated in the following manner in an HDD device using three discs of 3.5-inch double-side magnetic recording media, for example. The recording range is normally set from 17.85 to 47.00 mm, and if the track width is equal to 0.1 μm, 29,484 tracks are provided per surface, and a total of 2×3×29,484=176,904 tracks are provided in the HDD device. Therefore, an amount equivalent to 18 bits is needed. If the servo bit length at a radius of 17.85 mm is equal to 0.1 m, the total servo bit length is equal to 1.8 μm. If the servo bit length at a radius of 23.5 mm is equal to 0.13 μm, the total servo bit length is equal to 2.4 μm. Accordingly, “0” or “1” is continuously written during the total servo bit length in a servo signal having cylinder information of all “0” or “1”.

The sector information is an area obtained by dividing a track into 100 parts, and it is an area for writing and reading data in the HDD device. A sector address is normally represented by a binary digit. For example, when 90 sectors is provided on the whole periphery, the sector address has a 7-bit length.

The servo signal also includes servo burst information 34, which is needed to position the magnetic head onto a target track after the magnetic head is moved to the target track. In general, the magnetic head is positioned to the center of the target track by comparing the signal amplitudes of the signals displaced in phase by 180 degrees. A pattern shown in FIG. 3 is a burst pattern in which the phases of one track width A, B, C, D are displaced.

Data as well as the servo signal are written to the magnetic recording medium. RLL (Run Length Limited) codes are proposed for the data other than the servo signal. The original data are temporarily modulated and then written/read. Here, using the minimum magnetization reversal interval represented by d, the maximum magnetization reversal interval represented by k, the bit length of the original data represented by m, and the bit length after modulation represented by n, FIG. 5 shows an example of a bit sequence before and after modulation on the RLL1-7 code for d=1, k=7, and FIG. 6 shows the modulation rule of RLL. The RLL1-7 code is a code in which the maximum and minimum values of the magnetization reversal interval are equal to 1 and 7 respectively. In principle, 2-bit data are converted to 3-bit data, and a data sequence of 4 bits is converted to 6 bits. As described above, in the RL1-7 code, one “0” at maximum and seven “0” at maximum exist between “1” and “1,” and “0” or “1” is prevented from being continuous over a long section. If the data bit length is set to 0.1 μm, “0” or “1” can be continuous over 0.7 μm at maximum.

The magnetic transfer technique using the master disc has a problem in that when the same bit continues lengthily in a transfer pattern, the magnetic transit interval (the length of a section in which “0” or “1” continues) is increased and thus the magnetization is hardly reversed, so that it is difficult to perform stable magnetic transfer. That is, when the magnetic transit interval is increased, the magnetic flux density at the lower portion of the soft magnetic film is increased, and the initially demagnetized magnetic film on the recording medium is magnetized, so that the magnetization reversal is hardly performed.

FIGS. 7A-7C show the relationship between the position of the magnetic film of the magnetic recording medium and the magnetic flux density when the length and interval of the soft magnetic film are varied (in the case of the length W=0.7 μm and the interval P=1.4 μm and in the case of W=2.0 m and P=4.0 μm). As a measurement result, the magnetic flux density at the lower portion of the soft magnetic film is larger in the case of W=2.0 μm and P=4.0 μm. Ideally, it is preferable for the magnetic flux density in the magnetic film of the magnetic recording medium corresponding to the lower portion of the soft magnetic film to be equal to zero. However, when the length of the soft magnetic film is increased or the interval of the soft magnetic film is increased, the magnetic flux of the recording magnetic field flowing into the soft magnetic film is increased, and the magnetic flux density in the soft magnetic film is increased, so that the magnetic flux density exceeds the saturated magnetic flux density of the soft magnetic film. That is, this measurement result shows that the magnetic field leaks into the magnetic film of the magnetic recording medium. FIGS. 8A-8C show the magnetic saturation point at the lower portion of the soft magnetic film when the length and interval of the soft magnetic film are varied as in the case of FIGS. 7A-7C. Leakage of magnetic field due to magnetic saturation is understood from a measurement result of FIGS. 8B and 8C. In addition, it is understood that the magnetic flux density between different portions of the soft magnetic film is smaller in the case of W=2.0 μm and P=4.0 μm. This is because under the state where different portions of the soft magnetic film are spaced from each other, the magnetic flux passing through the soft magnetic film passes through the side nearer to the magnet, and the magnetic flux density in the magnetic film of the magnetic recording medium is reduced.

Accordingly, to surely carry out the magnetic transfer on the front surface of the magnetic recording medium, it is required to reduce the leaking magnetic flux density at the lower portion of the soft magnetic film and increase the magnetic flux density between the soft magnetic film and another soft magnetic film. However, if the length of the soft magnetic film is increased and the interval of the soft magnetic film is increased as described above, the above condition is not attained. The measurement result described above shows that there are differences of about three times in length (W) and twice in interval (P). When there are larger differences, the problem is more critical. For example, in the case of the 3.5-inch HDD device, the magnetic transit interval of the servo address information ranges from 0.1 to 2.4 μm, which shows a broad range of about 24 times. Therefore, the tendency described above is more remarkable, and in the worst case scenario, some areas do not undergo magnetization reversal. As a result, it is difficult to carry out stable magnetic transfer.

The present invention has been implemented in view of the foregoing problem. There remains a need for a master disc that can carry out magnetic transfer with high reliability. The present invention addresses this need.

### SUMMARY OF THE INVENTION

The present invention relates to a master disc and a method for manufacturing the same, and a method magnetic transfer to a magnetic recording medium.

One aspect of the present invention is a master disc. The master disc contains a magnetic layer with embedded converted bit information to be written as a magnetization pattern to a magnetic recording medium pattern. The converted bit information contains a predetermined number of converted blocks each containing at least three converted bits. Each of the converted blocks contains at least one bit having a different value.

Another aspect of the present invention is a method of manufacturing the master disc described above. The method can include providing a substrate, converting bit information to be transferred to a magnetic recording medium, so that the converted bit information contains a predetermined number of converted blocks each containing at least three converted bits. Each of the converted blocks contains at least one bit having a different value. The method further includes forming a magnetic layer on the substrate by embedding the converted bit information as a magnetization pattern.

Another aspect of the present invention is a method of magnetically transferring bit information to a magnetic recording medium. The method includes providing a master disc having converted bit information to be written as a magnetization pattern to a magnetic recording medium embedded therein, and bringing the master disc for magnetic transfer into contact with the recording medium so that the converted bit information is transferred to the magnetic recording medium. The converted bit information contains a predetermined number of converted blocks each containing at least three converted bits. Each of the converted blocks contains at least one bit having a different value.

In each of the above aspects of the present invention, the converted bit information can be converted from bit information having a predetermined number of blocks each containing two bits to the predetermined number of blocks each containing 3 to 10 bits. The bit information can be servo address information or cylinder information. Each of the converted blocks can contain equal number of bits having a value of “0” and a value of “1.” Each of the converted blocks can contains four bits, with one or two different bits between the first and last bits of the same bit value being different so that all of the bits of a sequence of all three or more of the bits do not contain the same bit value.

### BRIEF DESCRIPTION OF THE DRAWINGS

FIGS. 1A-1C are diagrams showing an initial demagnetizing step of a magnetic recording medium (FIG. 1A), master disc positioning step (FIG. 1B), and a transfer pattern writing step (FIG. 1C).

FIGS. 2A and 2B are diagram showing the initial demagnetizing step (FIG. 2A) and the transfer pattern writing step (FIG. 2B).

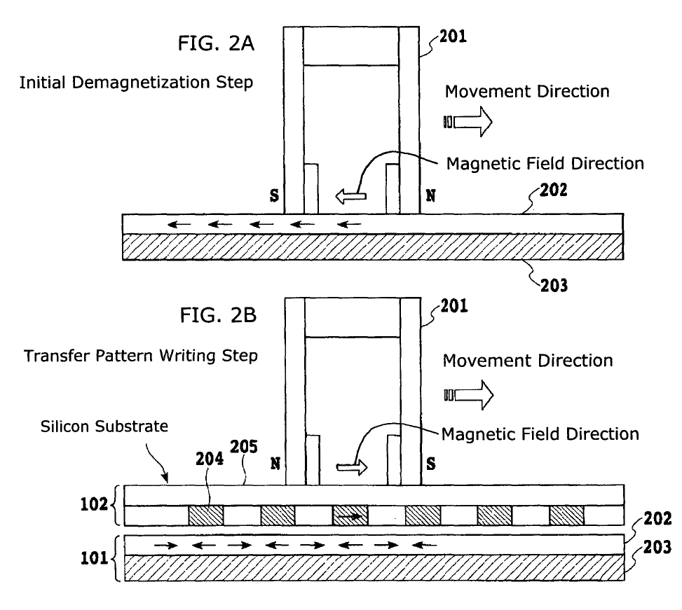

FIG. 3 is a diagram showing the pattern of the servo signal of the HDD device according to this invention.

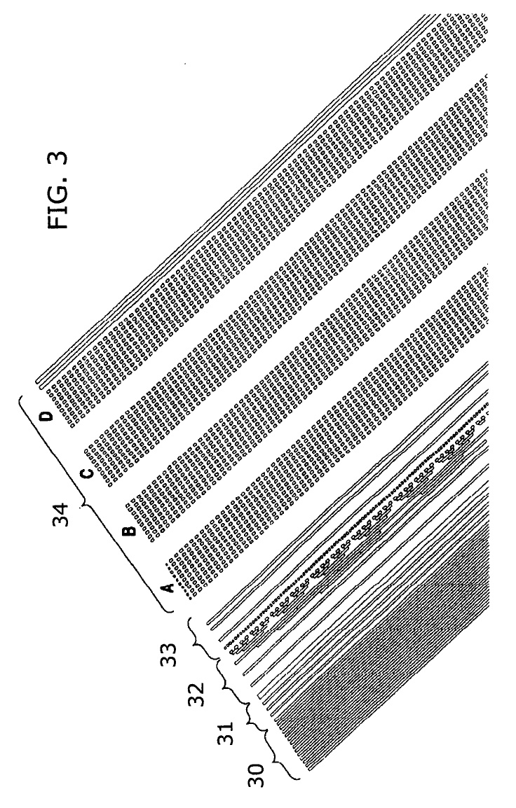

FIGS. 4A and 4B are diagram showing a conversion table when cylinder information according to an embodiment of this invention is gray-coded, FIG. 4A showing a conversion table from a binary code to a gray code, and FIG. 4B showing a conversion table when the gray code is actually applied to the cylinder information.

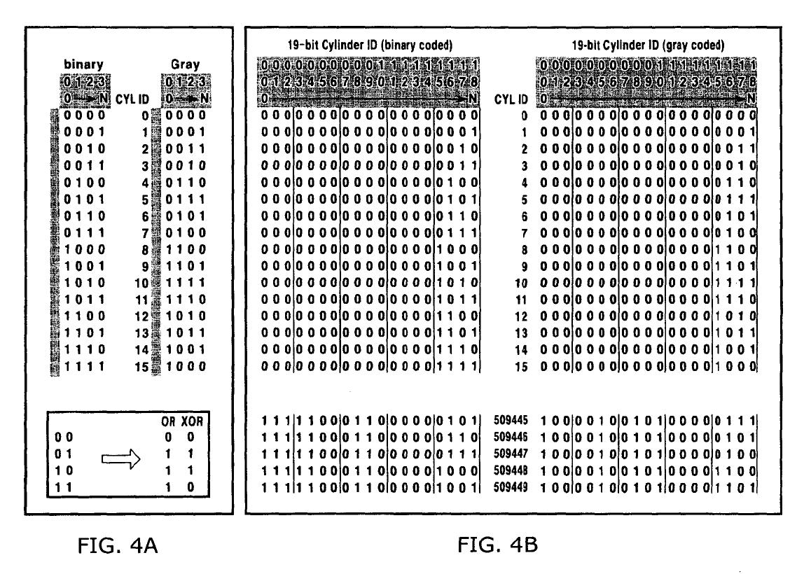

FIG. 5 is a diagram showing an example of a bit sequence before and after modulation for RLL1-7 code according to the embodiment of this invention.

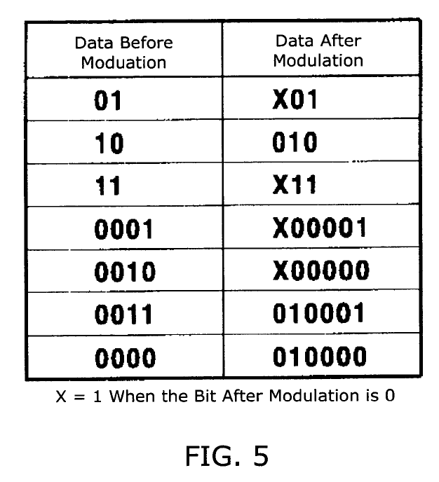

FIG. 6 is a diagram showing the modulation rule of RLL according to the embodiment of this invention.

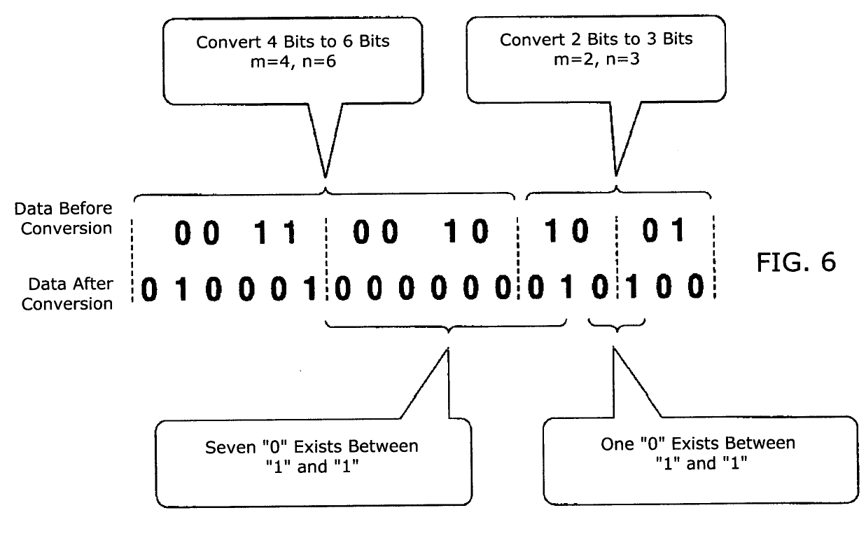

FIGS. 7A-7C are diagram showing the relationship between the position and magnetic flux density of magnetic film of a magnetic recording medium.

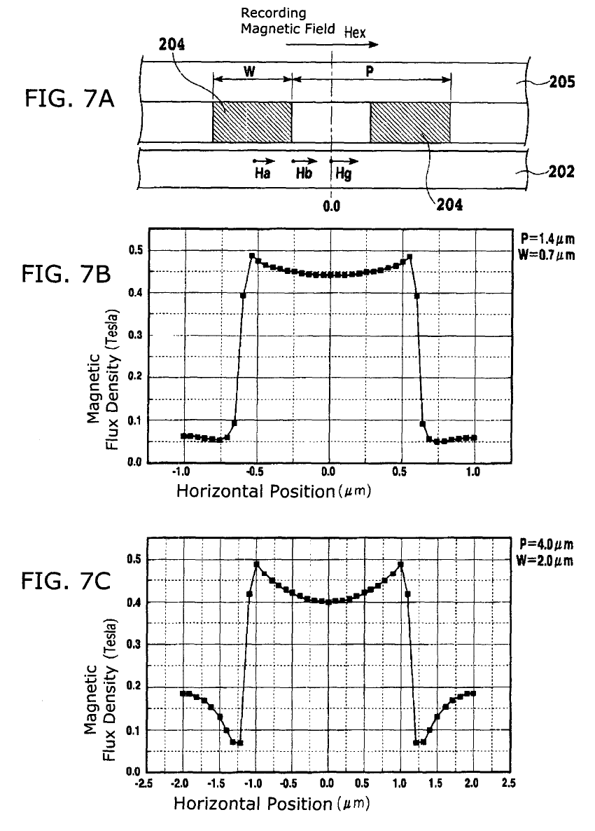

FIGS. 8A-8C are diagram showing a magnetic saturation point at the lower portion of soft magnetic film.

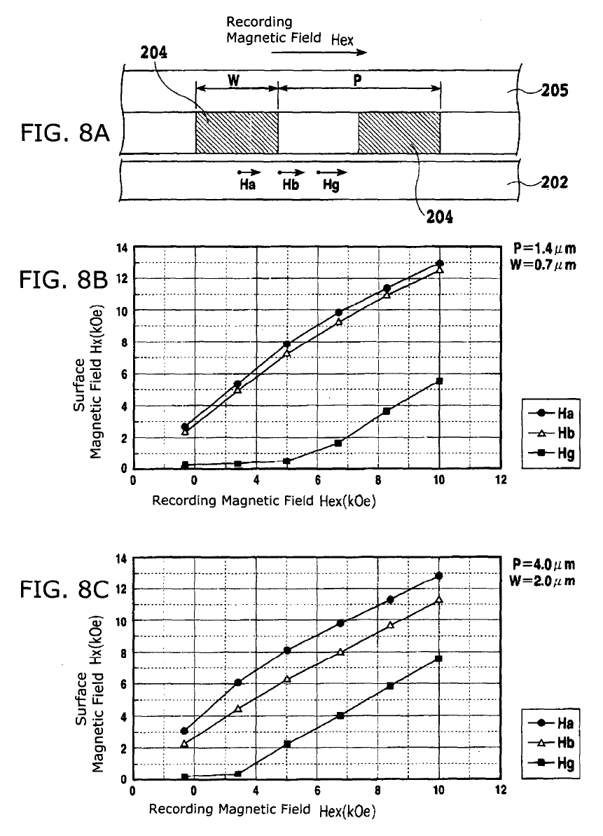

FIG. 9 is a diagram showing a code conversion (2-bit-4-bit) for servo address information of a servo signal according to this invention.

FIGS. 10A and 10B are diagrams showing servo address information (18 bits) to which the 2-bit to 4-bit conversion is applied.

FIG. 11 is a diagram showing a code conversion (2-bit to 3-bit) for the servo address information of the servo signal according to this invention.

FIGS. 12A and 12B are diagrams showing the servo address information (18 bits) to which the 2-bit to 3-bit conversion is actually applied.

FIG. 13 is a diagram showing a transfer flow chart of a magnetization pattern to a magnetic recording medium according to this invention.

### DETAILED DESCRIPTION

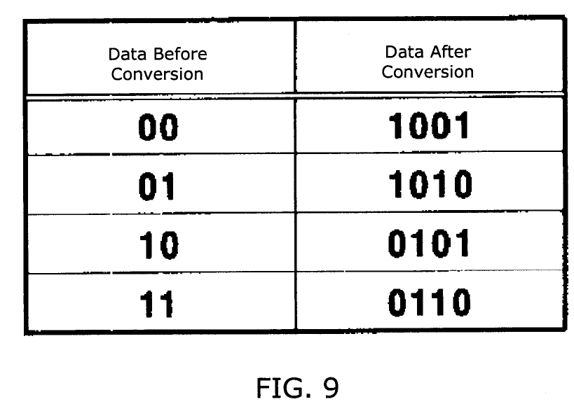

FIG. 9 is a diagram showing the code conversion (2-bit to 4-bit) for the servo information of the servo signal. In the 2-bit to 4-bit conversion of this embodiment, a bit sequence contained in bit information is divided every two bits and each 2-bit data is converted to 4-bit data so that “0” and “1” whose numbers are equal to each other, i.e., two “0” and two “1” are contained in the 4-bit data thus converted.

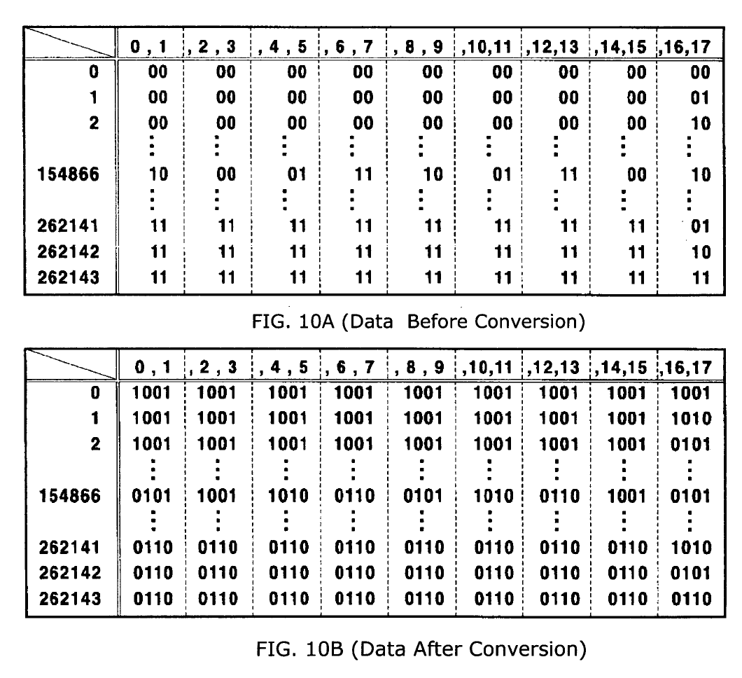

FIGS. 10A and 10B are diagrams showing the servo address information (18 bits) to which the 2-bit to 4-bit conversion shown in FIG. 9 is actually applied. FIG. 10A shows the bit sequence of the bit information before the conversion, and FIG. 10B shows the bit sequence after the conversion. It is understood that the servo address information after the conversion contains one or two different bits between a bit “0” and a bit “0” or between a bit “1” and a bit “1”, i.e., between the same bits (first and last), so that three or more of the same bits do not continue one after the other.

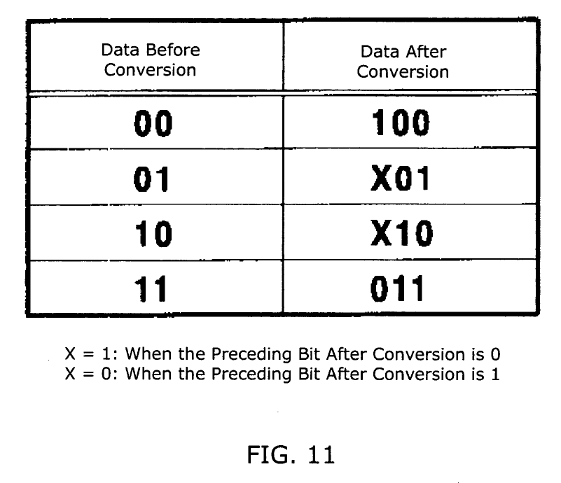

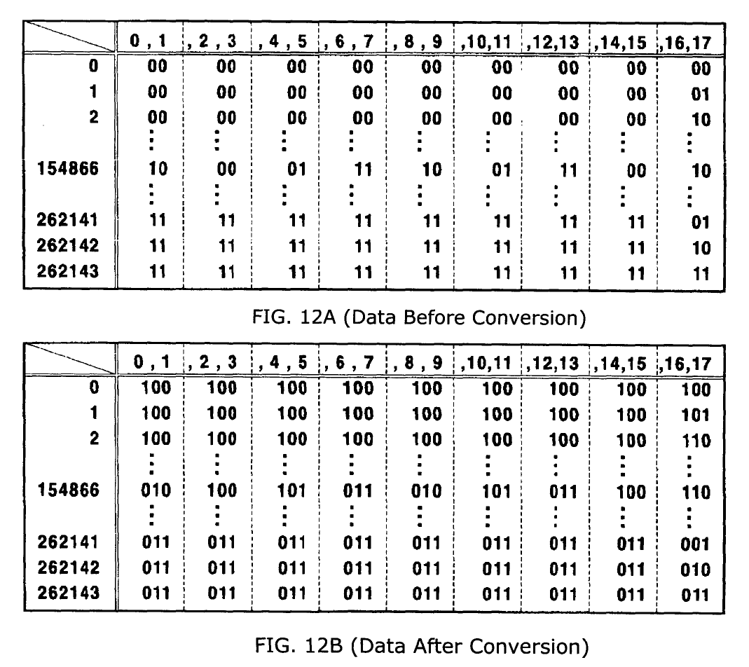

FIG. 11 shows an example of another conversion (2-bit to 3-bit conversion) of the servo address information. In this embodiment, the conversion is carried out so that 2-bit is converted to 3-bit and a different bit is necessarily contained in 3 bits. Furthermore, by introducing a variable bit X having a different bit value, which is based on the preceding bit value, attention is paid as much as possible so that the same bits are not sequential to each other. In this embodiment, X takes the inverse value of the preceding bit. That is, if the preceding value is equal to “1,” X is “0,” and if the preceding value is equal to “0,” X is “1.” FIGS. 12A and 12B are diagrams showing the servo address information (18 bits) to which the 2-bit to 3-bit conversion shown in FIG. 11 is actually applied as in the case of FIGS. 10A and 10B. FIG. 12A shows the bit sequence of bit information before the conversion, and FIG. 12B shows the bit sequence after the conversion.

The embodiments using the 2-bit to 4-bit conversion and the 2-bit to 3-bit conversion have been described above. The former has a feature that the conversion method is simple, and the latter has a feature that the number of bits to be increased through the conversion is small, and the conversion can be used in accordance with the characteristic of the HDD device.

Next, the servo address information converted through the conversion as described above is embedded as the servo pattern and the data pattern together with other information in the master disc. In this embodiment, a master disc can be manufactured by embedding a soft magnetic film formed in the above pattern on the silicon substrate. The master disc thus manufactured is brought into contact with a magnetic recording medium to form a magnetization pattern through magnetic transfer.

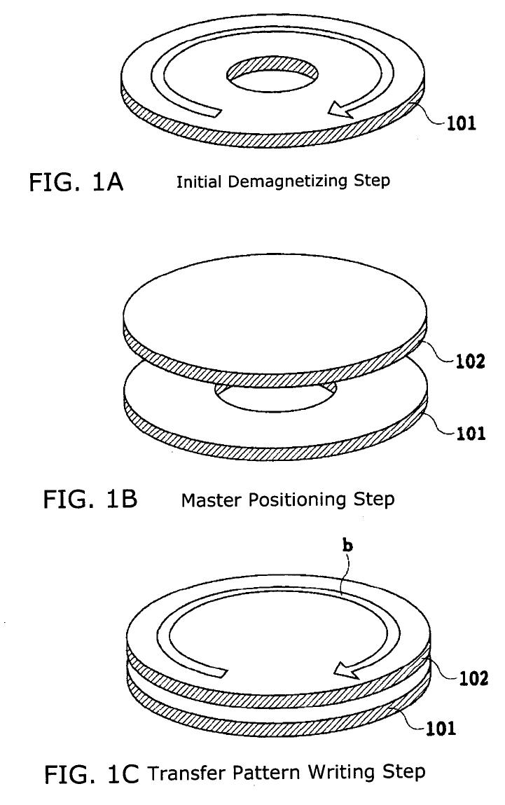

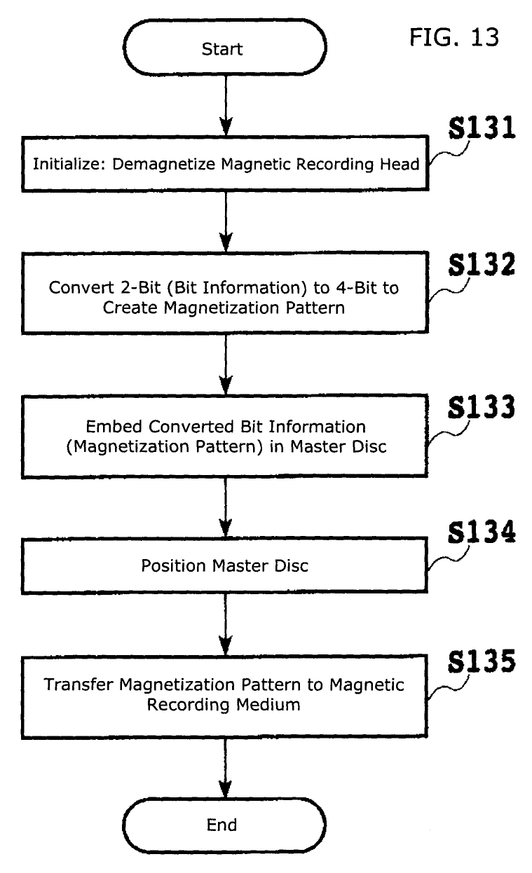

FIG. 13 is a diagram showing a transfer flow of a magnetization pattern to a magnetic recording medium. First, the magnetic recording medium is initialized by magnetizing the magnetic layer uniformly in the circumferential direction (S131). Subsequently, the original servo address information is subjected to the 2-bit to 4-bit conversion to create a magnetization pattern of a servo signal containing this information (S132). The pattern of the soft magnetic film is embedded in the master disc so that the magnetization pattern thus created is formed (S133). The master disc having the soft magnetic film embedded therein is disposed and positioned on the magnetic recording medium (S134). The permanent magnet for magnetic transfer is moved along the movement path indicated by the arrow b (FIG. 1C) while the master disc is brought into close contact with the surface of the magnetic recording medium, thereby magnetically transferring the servo signal embedded in the master disc to the magnetic recording medium (S135).

When writing/reading is carried out on the magnetic recording medium in the HDD device containing the magnetic recording medium, the servo address information converted at the design time of the master disc is read together with other servo signals by the magnetic head. By reading the servo address information and then carrying out the reverse conversion on the servo address information thus read, the original servo address information can be obtained. That is, the bit sequence read is divided every 4 bits in the case of the 2-bit to 4-bit conversion and by three bits in the case of the 2-bit to 3-bit conversion, the conversion described in the above embodiment is reversely executed to obtain the 2-bit data, and then the 2-bit data thus achieved are composed to obtain the original bit number (in the above example, 18 bits) of servo address information.

In this embodiment, although the unit of the data conversion is set to 2 bits, it is not necessarily limited to this bit number. Any conversion can be used insofar as it is data conversion for conversion to a code of bit number (n−2)/2+1 containing at least one “1” and at least one “0” bits when n represents the permissible bit number at which the magnetic transfer is stably carried out and the bit number not more than (n−2)/2 is set to a conversion unit. By using such a conversion, the servo address information after the conversion has different values of 1 to n between bits having the same value, and thus the same bit value sequence larger than n can be avoided.

As described above, according to the present invention, when the bit information is embedded in the master disc, the bit sequence contained in the bit information is converted in advance so that a different bit appears in the bit sequence every fixed bit number, so that the magnetic transit interval can be avoided from covering a broad range, and magnetic transfer can be performed with high reliability even when the width of the magnetic pattern is equal to sub-micron.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

The disclosure of the priority application, JP 2003-041804 in its entirety, including the drawings, claims, and the specification thereof, is incorporated herein by reference.

What is claimed is:

1. A master disc comprising:
a magnetic layer containing converted bit information embedded therein for transferring to a magnetic recording medium as a magnetic pattern,
wherein the converted bit information contains a predetermined number of converted blocks each containing at least three converted bits, each of the converted blocks containing at least one bit having a different value.

2. The master disc according to claim 1, wherein each of the converted blocks contains equal number of bits having a value of “0” and a value of “1”.

3. The master disc according to claim 1, wherein the converted bit information is converted from bit information having a predetermined number of blocks each containing two bits to 3 to 10 bits .

4. The master disc according to claim 3, wherein each of the converted blocks contains four bits, with one or two different bits between the first and last bits of the same bit value being different so that all of a sequence of three or more of the bits do not contain the same bit value.

5. The master disc according to claim 1, wherein the bit information is servo address information or cylinder information.

6. The master disc according to claim 2, wherein the bit information is servo address information or cylinder information.

7. The master disc according to claim 3, wherein the bit information is servo address information or cylinder information.

8. The master disc according to claim 4, wherein the bit information is servo address information or cylinder information.

9. A method of manufacturing a master disc, comprising the steps of:
providing a substrate;
converting bit information to be transferred to a magnetic recording medium, so that the converted bit information contains a predetermined number of converted blocks of at least three converted bits, each of the converted blocks containing at least one bit having a different value; and
forming a magnetic layer on the substrate by embedding the converted bit information as a magnetization pattern on the substrate.

10. The method according to claim 9, wherein each of the converted blocks contains equal number of bits having a value of “0” and a value of “1”.

11. The method according to claim 9, wherein the converted bit information is converted from bit information having a predetermined number of blocks each containing two bits to 3 to 10 bits.

12. The method according to claim 11, wherein each of the converted blocks contains four bits, with one or two different bits between the first and last bits of the same bit value being different so that all of a sequence of three or more of the bits do not contain the same bit value.

13. The method according to claim 9, wherein the bit information is servo address information or cylinder information.

14. A method of magnetically transferring bit information to a magnetic recording medium, comprising the steps of:
providing a master disc having converted bit information to be written as a magnetization pattern to a magnetic recording medium embedded therein; and
bringing the master disc for magnetic transfer into contact with the recording medium so that the converted bit information is transferred to the magnetic recording medium,
wherein the converted bit information contains a predetermined number of converted blocks of at least three converted bits, each of the converted blocks containing at least one bit having a different value.

15. The method according to claim 14, wherein each of the converted blocks contains equal number of bits having a value of “0” and a value of “1”.

16. The method according to claim 14, wherein the converted bit information is converted from bit information having a predetermined number of blocks each containing two bits to 3 to 10 bits.

17. The method according to claim 16, wherein each of the converted blocks contains four bits, with one or two different bits between the first and last bits of the same bit value being different so that all of a sequence of three or more of the bits do not contain the same bit value.

18. The method according to claim 14, wherein the bit information is servo address information or cylinder information.
